(19) United States
(12) Patent Application Publication
(10) Pub. No.: US 2008/0040743 A1
(43) Pub. Date: Feb. 14, 2008

(54) MICRO-SPLICER FOR INSERTING ALTERNATE CONTENT TO A CONTENT STREAM ON A HANDHELD DEVICE

(76) Inventor: Srinivasa Dharmaji, Sunnyvale, CA (US)

Correspondence Address: GLENN PATENT GROUP, 3475 EDISON WAY, SUITE L, MENLO PARK, CA, 94025, US

(21) Appl. No.: 11/828,204

(22) Filed: Jul. 25, 2007

Related U.S. Application Data
(60) Provisional application No. 60/834,039, filed on Jul. 29, 2006.

(51) Int. Cl. H04N 7/10

(52) U.S. Cl. 725/35

(57) ABSTRACT

In a targeted advertising system focused advertisements or alternate content is pre-stored on a handheld device, inserted into a multimedia stream at predefined times and points in the content stream for a predefined interval, otherwise referred to as a spot. A micro-splicer, instantiated on a handheld device, enables alternate content insertion into a content buffer, instead of the multicast original content stream, at available advertisement spots during content viewing. The alternate content for the target audience can be downloaded and stored on a handheld device prior to the arrival of the content stream. The micro-splicer uses metadata, transmitted within the content stream or notified by other means, to identify the correct alternate content and insert it into the correct spot for reproduction on the handheld device.

### CROSS REFERENCE TO RELATED APPLICATIONS

This application claims priority from the provisional patent application entitled Micro-Splicer in Mobile Device, Ser. No. 60/834,039, filed Jul. 26, 2006, which is hereby incorporated by reference for all that it contains.

### BACKGROUND OF THE INVENTION

1. Technical Field

The invention relates to the insertion of content into multimedia streams. More specifically, the invention relates to the insertion of advertisements and other alternate content at predefined spots within a multimedia content stream and, even more specifically, the invention relates to the rendering of focused advertisements and alternate content for viewing by a target audience on a handheld device.

2. Discussion of the Prior Art

The availability and growth of use of handheld, portable, and mobile devices (generally referred to herein as handheld devices), such as the personal digital assistant (PDA) and the cell phone, is revolutionizing the experience individuals has when view digital multimedia content viewing ability for individuals. Because each handheld device is specific to an individual, it is possible to personalize and focus advertisements, and other alternate content, to specific individuals, or groups of individuals, using targeted characteristics. Ideally, the advertisement for each individual should be tailored, or otherwise targeted, to fit the specific requirements of that specific individual. Therefore, it would be necessary to provide each individual with a specific advertising stream.

The problem that exists today in implementing such a scheme is that there is limited bandwidth available in systems, such as in point-to-point or multicast wireless broadcasting of digital multimedia content. Therefore it is impractical to provide each individual with a specifically targeted stream that fits that individual's characteristics. This limits the possibility of targeted include focused advertisements and alternate content that are targeted towards specific individuals or groups. This is due to the fact that in such case there are a substantial number of focused advertisements that must to be broadcast simultaneously to achieve the objective of focused advertising. In addition, each handheld device must be, capable of identifying and viewing the alternate content or advertisement that is specifically meant for that individual. Hence, even though the idea of providing focused advertisement and alternate content to target groups has been a desirable concept in the advertising to customers using handheld devices, it has not been possible to implement efficiently. Therefore the current practice for providing advertisements for viewing on handheld devices is to insert them into the content stream by splicing the advertisement either by altering the stream or prior to a multicast transmission.

It would therefore be advantageous to provide a method and a apparatus for providing advertisements and/or alternate content based on characteristics of an individual or a group of individuals. It would be further advantageous if such a solution allowed for the intelligent use of the available bandwidth of a multicast wireless broadcasting system.

### SUMMARY OF THE INVENTION

In a targeted advertising system focused advertisements or alternate content is pre-stored on a handheld device, inserted into a multimedia stream at predefined times and points in the content stream for a predefined interval, otherwise referred to as a spot. A micro-splicer, instantiated on a handheld device, enables alternate content insertion into a content buffer, instead of the multicast original content stream, at available advertisement spots during content viewing. The alternate content for the target audience can be downloaded and stored on a handheld device prior to the arrival of the content stream. The micro-splicer uses metadata, transmitted within the content stream or notified by other means, to identify the correct alternate content and insert it into the correct spot for reproduction on the handheld device.

In a targeted advertising system focused advertisements or alternate content is pre-stored on a handheld device, inserted into a multimedia stream at predefined times and points in the content stream for a predefined interval, otherwise referred to as a spot. A micro-splicer, instantiated on a handheld device, enables alternate content insertion into a content buffer, instead of the multicast original content stream, at available advertisement spots during content viewing. The alternate content for the target audience can be downloaded and stored on a handheld device prior to the arrival of the content stream. The micro-splicer uses metadata, transmitted within the content stream or notified by other means, to identify the correct alternate content and insert it into the correct spot for reproduction on the handheld device.

### BRIEF DESCRIPTION OF THE DRAWINGS

FIG. 1 is a diagram showing entities participating in micro-splicing according to the invention;

FIG. 2 is a diagram showing a scheme for alternate content insertion for interstitial content according to the invention;

FIG. 3 is a diagram showing a scheme for alternate content insertion for gateway content according to the invention;

FIG. 4 is a diagram showing a scheme for alternate content insertion for bumper content according to the invention;

FIG. 5 is a diagram showing a scheme for alternate content insertion for Overlay or Inlay content according to the invention;

FIG. 6 is a diagram showing a scheme for alternate content insertion for Forced content according to the invention; and

FIG. 7 is a diagram showing a scheme for no alternate content insertion according to the invention;

### DETAILED DESCRIPTION OF THE INVENTION

Apparatus system for targeted advertising prestores focused advertisements or alternate content on a handheld device and inserts the advertisements alternate content into a multimedia stream at predefined times and points in content stream for a predefined interval, otherwise referred to as a spot. A micro-splicer, instantiated on a handheld device, enables alternate content insertion into a content buffer, instead of the multicast original content stream, at available advertisement spots, during content viewing. The alternate content for the target audience can be downloaded and stored on a handheld device prior to the arrival of the content stream. The micro-splicer uses metadata, transmitted within the content stream or notified by other means, to identify the correct alternate content and insert it into the correct spot for reproduction on the handheld device.

More specifically, what is disclosed is a method and apparatus for inserting alternate digital content into a multimedia content broadcast that is directed to mobile portable devices in a system having tight synchronization. The disclosed micro-splicer can be used as the basis for inserting digital content, such as advertisements, preference based content, banners, public announcements, and emergency notifications etc., into broadcast multimedia during the viewing process, at a spot. This disclosed method does not alter the broadcast content stream. Rather, it replaces the broadcast content rendered from the content buffer with alternate content at the advertisement spot for a specified period, as defined by metadata supplied to the micro-splicer.

A micro-splicing capability is instantiated on a mobile handheld device to insert forced, preference or profile based, focused, alternate content, or focused advertisements to be rendered by the mobile media player. This insertion is done, at the available spot, for the identified period of time, based on metadata that is typically made available during the multicast/broadcast of multimedia content. In accordance with an embodiment of the disclosed invention, the alternate content is transferred and stored on the handheld device ahead of insertion time along with synchronization metadata. This synchronization metadata defines the exact period and synchronization information for alternate content buffering and rendering. Alternate content with synchronization metadata can hence be streamed through other transport mechanisms, such as cellular data networks, WiFi networks, or any other mobile device input/output mechanism. When the advertisement spot and advertisement identification metadata is received during the wireless broadcast of the multimedia content, it is recognized and the alternate content is synchronized, based on the synchronization metadata, at the handheld terminal. The micro-splicer decrypts the encrypted alternate content metadata within the content stream to detect a spot break related message. Based on the detected message, a command is provided (switch/inlay/overlay) for inserting the alternate content, and the mobile media player is instructed to start rendering the alternate content from the next buffer. It switches back to the original program stream once the alternate content has been rendered.

Though the method of transmission of the advertisement may vary depending on the transport characteristics of wireless data or broadcast networks, insertion of advertisement or alternate content is dependent on tight coupling of a micro-splicer and an alternate content scheduler that also resides on the handheld device. Inserting gateway, interstitial, bumper, or banner advertisements in the content buffer is an example of this interaction. The disclosed micro-splicing is the action of switching the loading of the content buffer for display from the media or content buffer to the alternate content buffer and back to the media or content buffer. This is done based on the deciphered and decrypted metadata provided with the alternate content and the metadata indicating the spot and alternate content identification that is provided with the incoming content stream. The disclosed micro-splicing hence refers to the inserting of alternate content into the content buffer of the mobile media player. It refers to a splicing-like interaction on the mobile device similar to that of ANSI/SCTE 30 (Digital Program Insertion) specifications, with a set of rules and metadata obtained through a backend data broadcast. Unlike the splicing in the digital cable specifications, there is no insertion of alternate content streams in place of original content streams. Rather, the media player rendering the original program content switches to the data in the alternate content buffer when metadata signaling for content switching occurs. Once the alternate content has been rendered in the advertisement spot, the micro-splicer switches the media player back to the original media content stream without loss of content.

Because the processing power of a mobile handheld device is limited and any additional processing is battery intensive, the micro-splicer should not excessively consume processing cycles. To achieve this effect, the micro-splicer has to function in tandem with the alternate content scheduler on the handheld device to detect content switch instructions within the metadata obtained through the transport channels. The micro-splicer typically works with a hardware or a software demultiplexer to obtain information on program switching. One exemplary solution for micro-splicing provides notifications from the demultiplexer to the micro-splicer of events recognized in the program stream during decryption. This, in turn, enables the micro-splicer to prepare and insert alternate content for insertion into the stream for display.

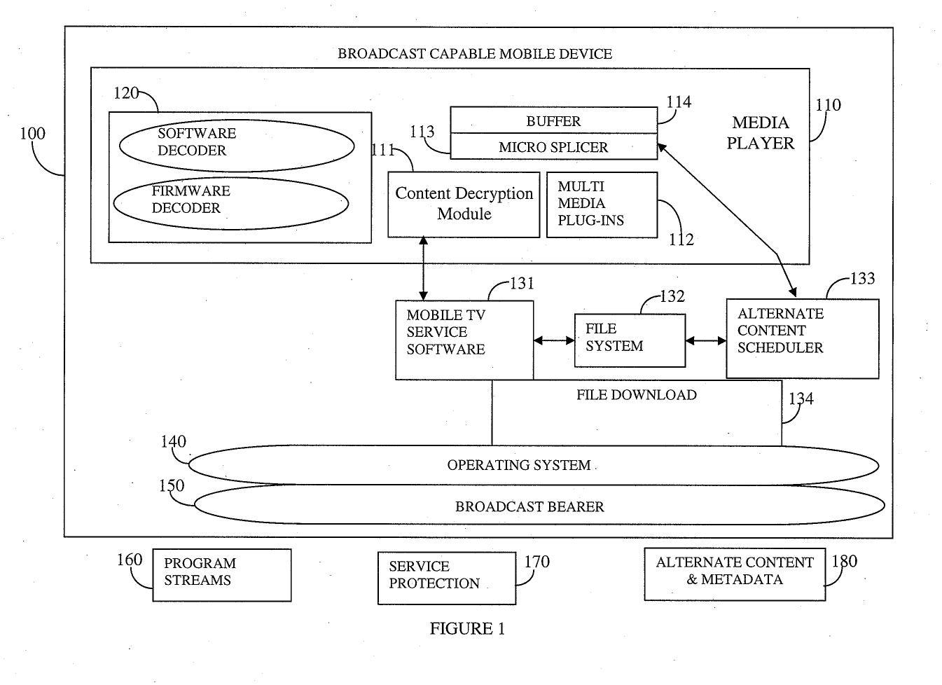

FIG. 1 illustrates the entities participating in micro-splicing in accordance with the disclosed invention. The main entity blocks of the micro-splicing architecture of a mobile handheld device 100 are the alternate content scheduler 133 and the micro-splicer 113. The alternate content scheduler 133 receives alternate content and related metadata 180 over a broadcast or a unicast channel. The alternate content scheduler 133 helps synchronize content switching on the mobile handheld device by notifying the micro-splicer 113 of the impending spot break or program switch/inlay/overlay command for inserting alternate content. Synchronization can also be aided by notifications from the micro-splicer 113 to the alternate content scheduler 133 upon detecting metadata periodically from the content streams, such as cue tones, e.g. ANSI 30, or other metadata. In such cases, the alternate content scheduler 133 prepares the appropriate locally stored file content to be rendered on the display 115 upon content switching.

The micro-splicer 113 acts as a thin pipe in the mobile media player 110 architecture. After the program streams 160 are received over the air and decrypted in the content decryption module 111, they are fed into the content buffer 114 through the micro-splicer 113. When the notification arrives from the alternate content scheduler 133 with details of the impending switch in content, the micro-splicer 113 starts buffering the alternate content in the next buffer in the content buffer 114. Depending on the type of alternate content insertion performed, the micro-splicer 113 also starts parsing the decrypted streams to detect spot break related messages, e.g. either a cue message or a proprietary command. Decryption of program streams is done in the content decrypting module 111.

Alternate content metadata in the content streams, such as cue tones, may also be presented as a separated control stream to the handheld device. In such case, the micro-splicer 113 decrypts the metadata using the spot owner's supplied keys and notifies the alternate content scheduler 133. Typically, these metadata events start arriving a few seconds before the actual content switch to be performed for alternate content insertion. This time period is used by the alternate content scheduler 133 to pre-buffer the alternate content and decode it in advance, if possible, so that the user can be presented with a synchronized alternate content viewing experience. Upon detection of this message, the micro-splicer 113 instructs the mobile media player 110 to start rendering the alternate content from the next buffer 114. The micro-splicer 113, in tandem with the alternate content scheduler 133, switches back to the original program streams once the alternate content has been rendered. The proper inbuilt or downloaded plug-ins are present in the media player.

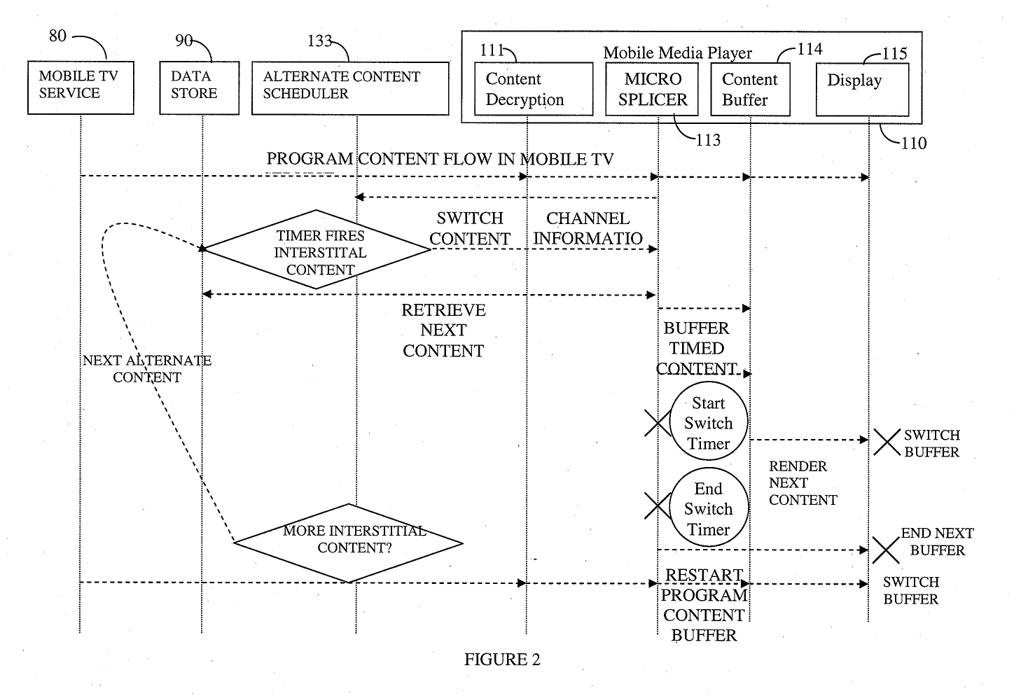

When mobile TV service is enabled for the mobile handheld device, program streams start flowing from the broadcast channel into the mobile device. The mobile TV service library on the mobile handheld device conveys the IP address and port to render the content to the mobile media player. The micro-splicer 113 conveys the program stream metadata information to the alternate content scheduler library for channel or program specific alternate content insertion. The message flows for different alternate content insertion scenarios. The assumptions for all the message flows described in this section are:
1. A mobile TV application/service 131 is available on the mobile handheld device and a broadcast network enabled for mobile TV service 80 (see FIG. 2) delivery to mobile devices.
2. The mobile media player has the micro-splicer 113 component integrated with the framework.
3. The alternate content scheduler software library is installed within the alternate content scheduler, 133 on the mobile device.
4. The alternate content scheduler software library stores the alternate content and corresponding metadata obtained from broadcast or unicast channel on the mobile device file system prior to any insertion.
5. If the alternate content or associated spot metadata is encrypted, the alternate content scheduler uses the alternate content inventory ownership and rules to acquire keys required for decryption.
6. The micro-splicer 113 uses the decoder component 120 on the mobile device (software or firmware) to decode alternate content before rendering.

Several possible scenarios exist for insertion of differing content types using the micro-splicer 113. In each and every case, the micro-splicer 113 looks for metadata input regarding the content and also the metadata on the advertisement space availability and inserts alternate content stored in the alternate content buffer. This is done by changing the content insertion path to the content buffer 114 from the program content flow, as instructed by the alternate content scheduler 133. At the end of the advertisement space, defined by the metadata, the micro-splicer 113 redirects the path of insertion from the alternate content buffer to the program content flow again under instruction from the scheduler 133. Hence, the micro-splicer performs the insert operation by redirecting the input path to the content buffer from the program content flow to the alternate content buffer and back at the appropriate points in the display stream based on the metadata inputs received and decoded in the mobile portable device 100. Six exemplary scenarios that exist within this framework are:
1. Alternate content insertion for interstitial content.
2. Alternate content insertion for gateway content.
3. Alternate content insertion for bumper content.
4. Alternate content insertion for overlay or inlay content.
5. Alternate content insertion for forced content.
6. No alternate content insertion scenario.

Each of these scenarios shall be now explained in more detail. These scenarios and descriptions thereof are provided as exemplary embodiments of the disclosed inventions and are not intended to be viewed as a limitation on the scope of the disclosed invention.

FIG. 2 illustrates alternate content insertion for interstitial content according to the invention.
1. Program content is received by the broadcast/unicast chipset of the mobile handheld device.
2. The mobile TV service library 80 informs the media player 110 of the IP address/port to listen for the program streams.
3. After a service protection scheme is enforced on the mobile device, the decrypted program streams are sent to the micro-splicer 113 to be buffered in buffer 114.
4. The mobile media player 110 renders and displays 115 the program streams.
5. The micro-splicer 113 informs the alternate content scheduler 133 library of the program stream being played and the associated data.
6. The alternate content scheduler 133 library obtains the channel information through interactions with mobile TV 80 software library, if necessary.
7. An internal timer for interstitial content fires, and the alternate content scheduler 133 library informs the micro-splicer 113 of an impending command for program switch and of the location (URL) of the alternate content that must to be rendered.
8. The micro-splicer 113 starts parsing the program streams for commands to switch content.
9. The micro-splicer 113 starts buffering the alternate content from the specified location on the mobile handheld device.
10. Upon detection of the alternate content rendering command, the micro-splicer 113 stops buffering the original program stream.
11. The micro-splicer 113 directs the rendering component of the mobile media player to display the buffered alternate content, and notifies the alternate content scheduler 133.
12. The alternate content scheduler 133 starts a timer upon notification for a duration minus X units of the pre-stored content being rendered.
13. Upon firing of timer for rendering alternate content, if there is more alternate content, steps 6 though 12 are repeated.
14. If all scheduled alternate content is played, the scheduler 133 notifies the micro-splicer 113 to start re-buffering original program content.
15. The micro-splicer 113 starts buffering of the original program stream.
16. When the end timer for alternate content fires, the scheduler 113 notifies the micro-splicer to switch buffer.
17. The micro-splicer 113 instructs the rendering engine (not shown) of the mobile media player 110 to start original program content display.

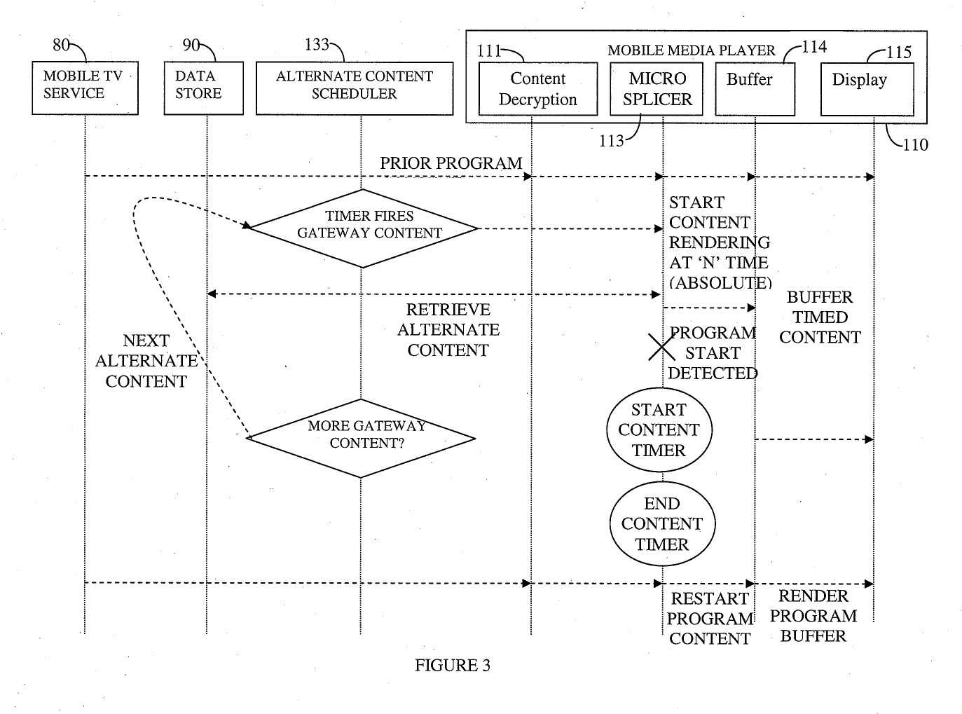

FIG. 3 illustrates alternate content insertion for gateway content according to the invention. The alternate content scheduler 133 has the information of the currently viewed program and channel by the mobile handheld device. Gateway content is the alternate content that is displayed before the start of a program. Typically, messages or content from entities, e.g. sponsored media, that sponsor the program are displayed.
1. The mobile media player renders prior program content.
2. The alternate content scheduler 133 detects the impending program start and commands the micro-splicer 113 to start rendering alternate content after time N.
3. The micro-splicer 113 retrieves the alternate content from the local file store provided in the previous step.
4. The alternate content is buffered in buffer 114.
5. The micro-splicer 113 starts looking for a program start command and detects same in the program content stream.
6. The micro-splicer 113 notifies the alternate content scheduler 133 when the program start command is detected.
7. The alternate content scheduler 133 starts an internal timer upon notification.
8. X-units before program end, the scheduler 133, determines if there is any more alternate content to be rendered.
9. Steps 1 through 8 are repeated until all alternate gateway content is rendered.
10. If all alternate gateway content is played, the scheduler 133 notifies the micro-splicer 113 to restart buffering the original program content.
11. The micro-splicer 113 starts buffering the original program content.
12. When the end timer for alternate content fires, the scheduler 133 notifies the micro-splicer 113 to switch buffer 114.
13. The micro-splicer 113 instructs the rendering component of mobile media player 110 to start the original program content display.

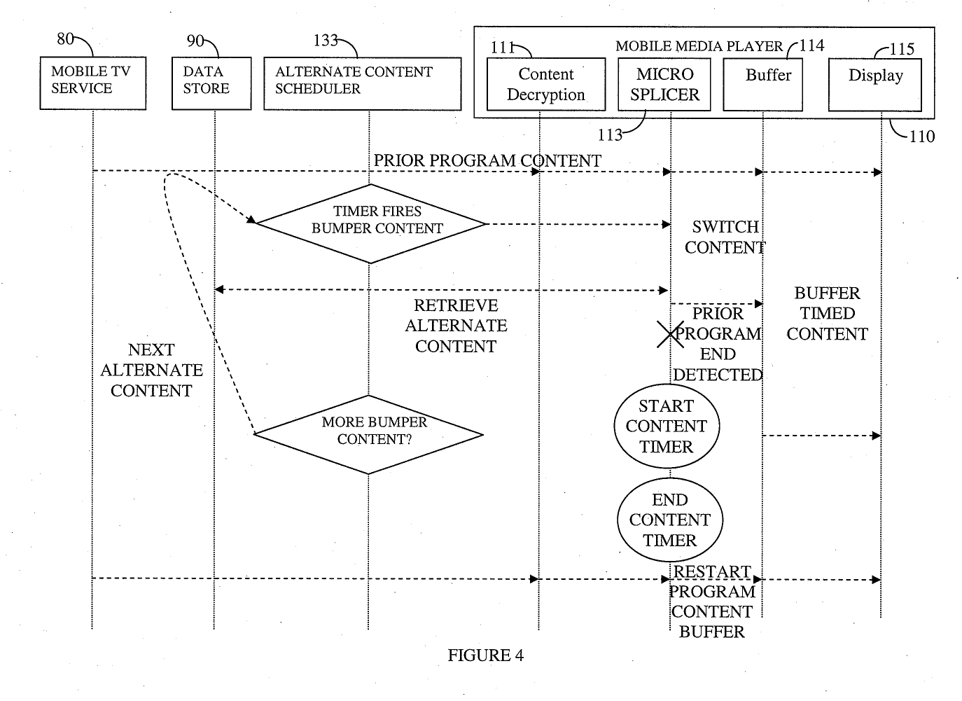

FIG. 4 illustrates alternate content insertion for bumper content according to the invention. The assumptions for alternate content insertion bumper content are that the alternate content scheduler 133 has the information on currently viewed program and channel on the mobile handheld device, and that the bumper content is the alternate content that is displayed at the end of programs. Typically, messages or content from entities, e.g. sponsored media, that sponsor the program are displayed. The operation is then as follows:
1. The mobile media player 110 renders prior program content.
2. The alternate content scheduler 133 detects the impending program end and commands the micro-splicer 113 to start rendering alternate content.
3. The micro-splicer 113 retrieves the alternate content from the URL provided in the previous step.
4. The alternate content is buffered in the buffer 114.
5. The micro-splicer 113 starts looking for a program end command or metadata and detects it in the program content stream.
6. The micro-splicer 113 commands the rendering component to start displaying the buffered alternate content on display 115 and notifies the scheduler 133.
7. The alternate content scheduler 133 starts an internal timer upon notification
8. X-units before program end, the scheduler 133 determines if there is any more alternate content to be rendered.
9. Steps 1 through 8 are repeated until all alternate gateway content is rendered.
10. If all alternate gateway content is played, the scheduler 133 notifies the micro-splicer 113 to restart buffering the original program content.
11. The micro-splicer 113 starts re-buffering the original program content.
12. When the end timer for alternate content fires, the scheduler 133 notifies the micro-splicer 113 to switch to buffer 114.
13. The micro-splicer 113 instructs the rendering component of the mobile media player 110 to display the original program content the display 115.

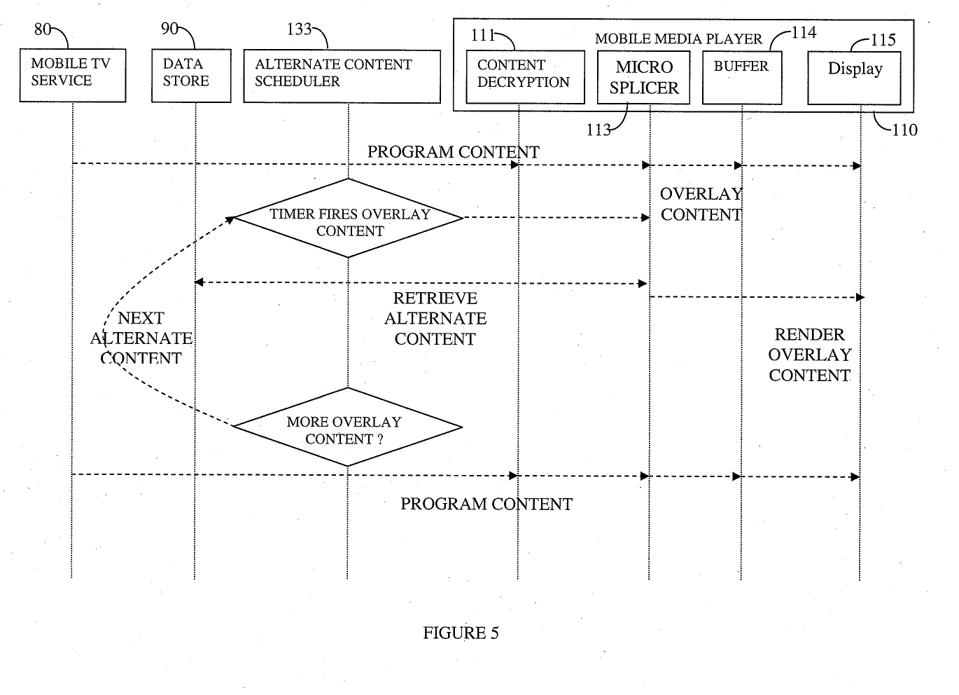

FIG. 5 illustrates the alternate content insertion for overlay or inlay content according to the invention. The assumptions for alternate content insertion for overlay or inlay content is that the alternate content scheduler 133 has information on the currently viewed program and channel on the mobile device. Typical examples of this type of content include banners, text messages, pictures, etc., which are rendered in a small portion of the display screen for inlay, and which occupy the entire screen for overlays.
1. The mobile media player 110 renders prior program content.
2. The alternate content scheduler 133 detects a time for content overlay or inlay and commands the micro-splicer 113 to start rendering alternate content and display the content on the display 115 per rules obtained from the network.
3. The micro-splicer 113 retrieves the alternate content from the URL provided in the previous step.
4. The alternate content is buffered to the buffer 114.
5. The micro-splicer 113 instructs the rendering engine of the mobile media player to overlay or inlay content while enforcing the display rules obtained in Step-1.
6. Steps 1 through 4 are repeated until all alternate overlay or inlay content is rendered.
7. The mobile media player 110 continues rendering the original program content.

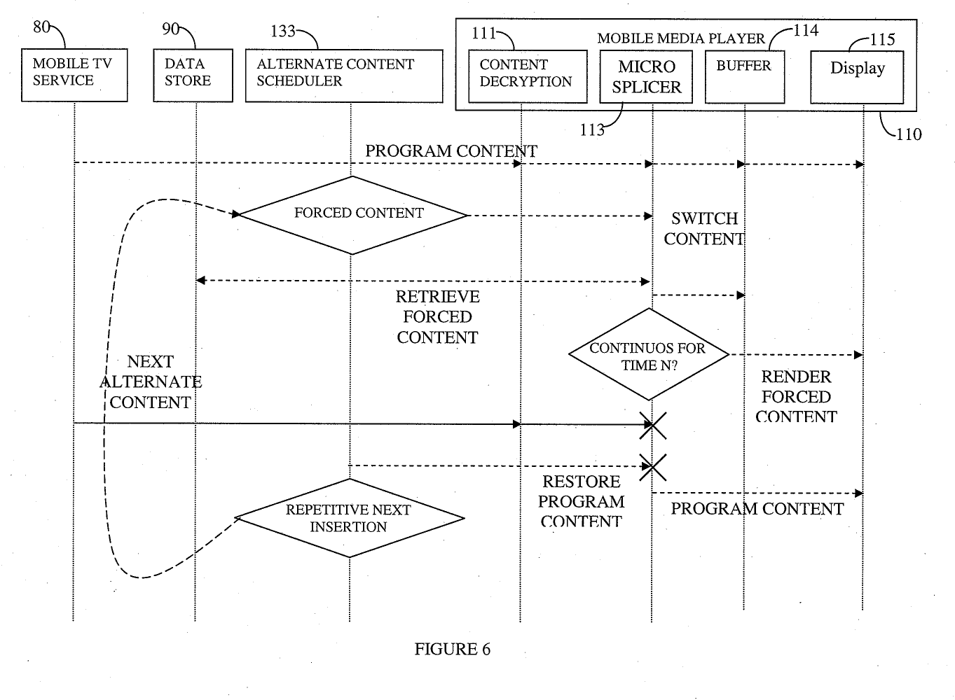

FIG. 6 that illustrates alternate content insertion for forced content according to the invention. The alternate content scheduler 133 has information on the currently viewed program and channel on the mobile handheld device. Forced content, such as emergency notifications or public announcements, can be either downloaded as a file or the network can broadcast the information as a stream. This scenario takes into account both cases, where the alternate content scheduler 133 controls the timing and synchronization aspects of forced content rendering and reverts back to original program content once the alternate content rendering is completed.
1. The mobile media player 110 renders the prior program content.
2. The alternate content scheduler 133 detects the time for inserting forced content into the display 115 and commands the micro-splicer 113 to start rendering alternate content and display the content per rules obtained from the network.
3. The micro-splicer 113 retrieves the alternate content from the information provided in Step-1.
4. Alternate content is buffered to the buffer 114.
5. The micro-splicer 113 instructs the rendering engine of the mobile media player 110 to display the alternate forced content, repeating the play of the content continuously as specified by the alternate content scheduler 133.
6. The micro-splicer 113 stops buffering the original program content.
7. The alternate content scheduler 133 detects the end of forced content and commands the micro-splicer 113 to restart original program content rendering.
8. If the alternate forced content must be rendered at network specified intervals, as instructed in the metadata, a timer is started in the alternate content scheduler 133 to render the forced content repetitively.
9. The mobile media player 110 continues rendering the original program content.
10. For repetitive display of forced content, Steps 1 through 8 above are repeated until all repetitions are completed.

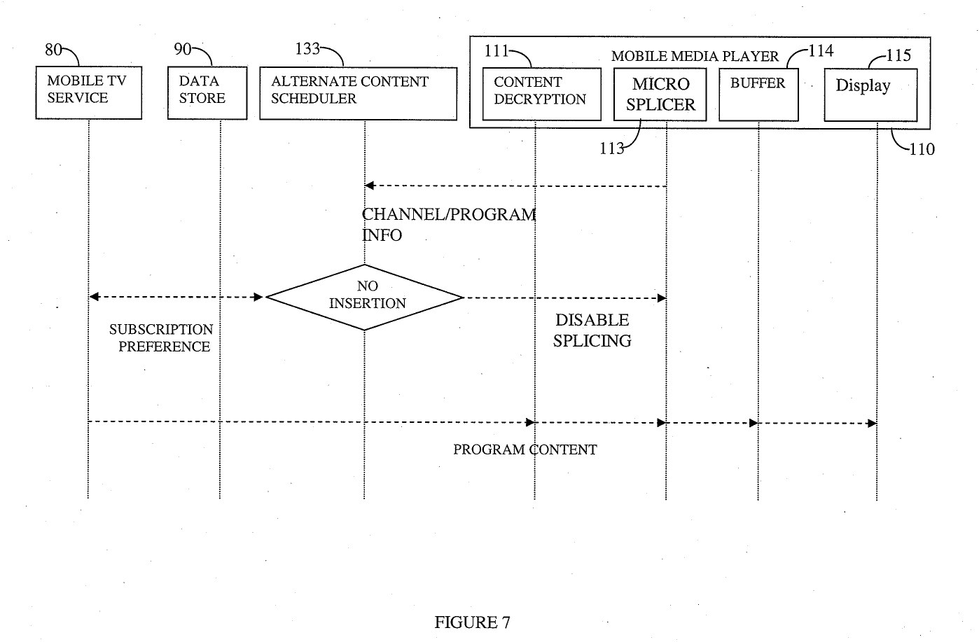

FIG. 7 illustrates a no alternate content insertion scenario according to the invention. If the subscription for the channel as viewed does not qualify for alternate content insertion, the micro-splicer 113 acts as a pipe for original program content rendering. The message flow details are:
1. The micro-splicer 113 provides information about the channel/program content to the alternate content scheduler 133.
2. The alternate content scheduler 133 interacts with the mobile TV service 80 of the mobile handheld device to obtain subscription preferences for the channel being viewed by the user.
3. The alternate content scheduler 133 commands the micro-splicer 113 to disable splicing for the period of the program, as obtained from the subscription preferences.
4. The mobile media player 110 continues rendering the original program content.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for inserting alternate multimedia content into multimedia program content in a mobile handheld device with tight synchronization, comprising:
a micro-splicer for redirecting multimedia content;
a buffer, coupled to the micro-splicer, for to storing a multimedia program content and/or alternate multimedia content; and
a scheduler, coupled to the micro-splicer, for the switching between the alternate multimedia content and the multimedia program content based upon synchronization information;
wherein the multimedia program content is broadcast in real-time, the alternate multimedia content is broadcast separately from the multimedia program content, and the insertion of the alternate multimedia content is tightly synchronized with the multimedia program content by said scheduler.

2. The apparatus of claim 1, wherein said synchronization information is provided to the apparatus as a metadata of at least the multimedia program content.

3. The apparatus of claim 2, wherein said metadata is provided to the scheduler.

4. The apparatus of claim 3, wherein the scheduler effects redirection of multimedia content by means of the micro-splicer at a precise time and based upon said metadata.

5. The apparatus of claim 4, wherein said tight synchronization is achieved by tandem operation of the micro-splicer and the scheduler.

6. The apparatus of claim 1, wherein said alternate multimedia content comprises an advertisement.

7. The apparatus of claim 1, wherein the alternate multimedia content comprises any of interstitial, gateway, bumper, overlay, inlay, and forced content.

8. The apparatus of claim 1, wherein said micro-splicer redirects any of the program, channel, alternate content metadata, service delivery, and subscription information.

9. A method for inserting alternate multimedia content into multimedia program content that is broadcast to a mobile handheld device, comprising the steps of:
receiving the alternate multimedia content at the mobile handheld device over a broadcast or a unicast channel;
storing the received alternate content at the mobile handheld device in a buffer;
receiving the multimedia program content and related metadata at the mobile handheld device over a broadcast or a unicast channel;
feeding the multimedia program content for rendering and display;
progressing the multimedia program content to detect spot break related metadata;
causing the feeding of the alternate multimedia content from the buffer for rendering and display instead of feeding the multimedia program content upon detection of spot break related metadata; and
switching back to the multimedia program content once the alternate multimedia content has been rendered and displayed.

10. The method of claim 9, wherein the step of receiving alternate multimedia occurs prior to the spot break in the multimedia program content.

11. The method of claim 9, wherein the step of switching between the alternate multimedia content and the multimedia program content and vice versa is tightly synchronized.

12. The method of claim 9, wherein the step of switching back to the multimedia program content is responsive to a trigger results from a metadata indication of a time period that is available for feeding of the alternate multimedia content.

13. The method of claim 9, wherein the alternate multimedia content comprises an advertisement.

14. The method of claim 9, wherein the alternate multimedia content comprises any of interstitial, gateway, bumper, overlay, inlay, and forced content.

15. The method of claim 9, wherein said spot break metadata switches any of program, channel, alternate content metadata, service delivery, and subscription information.

16. In an electric communication path, a multimedia program content signal comprising:
a stream of multimedia content;
metadata with said stream of multimedia content that is synchronized with said multimedia;
wherein said metadata identify at least one spot break in said multimedia content.

17. The multimedia program content signal of claim 16, wherein said metadata comprises means for enabling insertion of a stream of an alternate multimedia as part of the multimedia program content in response to reception of metadata that identifies a spot break.

18. The multimedia program content signal of claim 17, wherein said metadata comprises means for setting of a period length in which said alternate multimedia content stream is inserted as part of the multimedia program content in place of the multimedia program content.

19. The multimedia program content stream of claim 17, wherein said metadata comprises means for effecting tight synchronization between said multimedia program content stream and said alternate multimedia content stream.

20. The multimedia program content stream of claim 17, wherein said metadata comprises means for the inserting any of the following types of the alternate multimedia content: interstitial, gateway, bumper, overlay, inlay, and forced content.

21. The multimedia program content stream of claim 17, wherein said metadata enables insertion of any of program, channel, alternate content metadata, service delivery and subscription information.

22. An apparatus for inserting alternate multimedia content into multimedia program content that is broadcast to a mobile receiver, comprising:
means for enabling a mobile service at said mobile receiver;
a decoder for decoding incoming multimedia program content at said mobile receiver;
a media player at said mobile receiver comprising:
a content decryption module;
at least one multimedia plug-in;
a content buffer module;
a micro-splicer module for detecting and decrypting metadata contained within the multimedia program content and for the inserting alternate multimedia content or the multimedia program content into the content buffer module;
a scheduler for switching back and forth between the multimedia program content and the alternate multimedia content, based upon said metadata; and
a display module for displaying the contents of the content buffer;
wherein the stored, alternate multimedia content is synchronously inserted into a multimedia program at identified by said metadata spot breaks.

23. The apparatus of claim 22, wherein the micro-splicer and the scheduler create in tandem to provide seamless insertion and display of the alternate multimedia content.

24. The apparatus of claim 22, wherein the alternate multimedia content comprises any of an advertisement; and/or any of interstitial, gateway, bumper, overlay, inlay, and forced content.

25. (canceled)

26. The apparatus of claim 22, wherein said micro-splicer inserts any of program, channel, alternative content metadata, service delivery, and subscription information.
